(19) United States
(12) Patent Application Publication
(10) Pub. No.: US 2026/0336136 A1
(43) Pub. Date: Oct. 29, 2026

(54) VARIABLE STIFFNESS TUBE AND VARIABLE STIFFNESS MODULE OF CONTINUUM ROBOT

(71) Applicant: CHONGQING UNIVERSITY, Chongqing (CN)

(72) Inventors: Shuxin WANG, Chongqing (CN); Lei MAO, Chongqing (CN); Jinglei ZHAO, Chongqing (CN); Huayan PU, Chongqing (CN); Jun LUO, Chongqing (CN)

(21) Appl. No.: 19/702,086

(22) Filed: Jun. 9, 2026

Related U.S. Application Data
(63) Continuation of application No. PCT/CN2025/084360, filed on Mar. 24, 2025.

(30) Foreign Application Priority Data
Dec. 11, 2024 (CN) 202411818307.2

(51) Int. Cl. B25J 18/06; B25J 9/06; B25J 9/20; B25J 19/00

(52) U.S. Cl. CPC B25J 18/06; B25J 9/065; B25J 9/20; B25J 19/0054

(57) ABSTRACT

Provided are a variable stiffness tube and a variable stiffness module of a continuum robot. The variable stiffness tube includes a flexible inner tube and a flexible outer tube sleeved outside the flexible inner tube, a phase change material and a flexible heat exchange apparatus are arranged between the flexible inner tube and the flexible outer tube, and the heat exchange apparatus can exchange heat with the phase change material and cause the phase change material to change from a solid phase to a liquid phase. A flexible tube is further disposed in a filling space, multiple hollow slot groups are formed in a tube wall of the flexible tube in a penetrating manner, and each hollow slot is filled with the phase change material. When the phase change material is in the liquid phase, the flexible tube can bend freely.

### CROSS REFERENCE TO RELATED APPLICATION

This national application is a continuation application being filed under 35 USC 111(a) of International Patent Application No. PCT/CN2025/084360, filed on Mar. 24, 2025, which claims the priority of Chinese Patent Application No. 2024118183072 entitled “VARIABLE STIFFNESS TUBE AND VARIABLE STIFFNESS MODULE OF CONTINUUM ROBOT” filed with the Chinese Patent Office on Dec. 11, 2024.

### TECHNICAL FIELD

The present disclosure relates to the technical field of continuum robots, and in particular to a variable stiffness tube and a variable stiffness module of a continuum robot.

### BACKGROUND

Stiffness refers to the ability of a material to resist deformation, and a variable stiffness tube is a type of tube material with changeable stiffness. This tube material can change its own stiffness characteristics according to external temperature change so as to adapt to different engineering application requirements. Compared with a conventional fixed stiffness tube material, the variable stiffness tube has better flexibility and adaptability. In the technical field of continuum robots, how to adjust and control stiffness to meet different task requirements has become an important research topic. For example, in minimally invasive surgery or natural orifice endoscopic surgery, the continuum robot needs to be in a low-stiffness state to minimize side effects on a patient when being inserted into a human body, and when reaching a target region, the continuum robot needs to be converted into a high-stiffness level to transmit an acting force and ensure motion accuracy to reduce trauma. Therefore, the variable stiffness tube is widely used in the technical field of continuum robots. In an existing variable stiffness tube, its inner cavity is typically filled with a phase change material. The variable stiffness tube is stiffened by enabling the phase change materials in solid phase, and when subjected to bending deformation, bending stress is generated inside the variable stiffness tube. As the phase change material is prone to structural defects during cooling and solidification, the fracture of the tube is caused when the bending stress borne by the tube becomes excessive.

### SUMMARY

The embodiments aim to provide a variable stiffness tube and a variable stiffness module of a continuum robot, thereby solving the problems in the prior art, improving stiffness of a tube body under the action of a bending moment, and reducing the deformation of the tube that undergoes the bending moment when a phase change material is in a solid phase.

To achieve the objective described above, the present disclosure provides the following solutions.

The present disclosure provides a variable stiffness tube, including a flexible inner tube (1) and a flexible outer tube (2) sleeved outside the flexible inner tube (1). A filling space (3) with both ends capable of being sealed is formed between the flexible inner tube (1) and the flexible outer tube (2). A phase change material (7) and a flexible heat exchange apparatus (4) are arranged in the filling space (3). The heat exchange apparatus (4) is capable of exchanging heat with the phase change material (7) and causing the phase change material (7) to change from a solid phase to a liquid phase. A flexible tube (5) is further disposed in the filling space (3). Multiple hollow slot groups (51) are formed in a tube wall of the flexible tube (5) in a penetrating manner. Each of the multiple hollow slot groups (51) includes at least one hollow slot, and the at least one hollow slot is filled with the phase change material (7). When the phase change material is in the liquid phase, the phase change material (7) is capable of flowing freely, and the flexible tube (5) is capable of bending freely.

In an implementation, the heat exchange apparatus (4) is further capable of exchanging heat with the phase change material (7) to cause the phase change material (7) to change from the liquid phase to the solid phase.

In an implementation, each of the at least one hollow slot in each of the multiple hollow slot groups (51) is arranged along a circumferential direction of the flexible tube (5) and extends along the circumferential direction of the flexible tube (5). A total perimeter of the at least one hollow slot in each of the multiple hollow slot groups (51) is less than a perimeter of the flexible tube (5). Hollow slots in the plurality of hollow slot groups (51) are arranged alternately on the flexible tube (5) in an axial direction. In the axial direction, projections of all hollow slots in any adjacent hollow slot groups of the multiple hollow slot groups (51) onto a cross-section of the flexible tube (5) completely cover the cross-section.

In an implementation, the heat exchange apparatus (4) includes one or more flexible heat exchange tubes (41), which is configured to allow a heat exchange medium to flow therein, enabling heat exchange with the phase change material (7).

In an implementation, one flexible heat exchange tube (41) is disposed, and the one flexible heat exchange tube (41) is helically and seamlessly wound around an outside of the flexible inner tube (1).

In an implementation, multiple flexible heat exchange tubes (41) are disposed, and the multiple flexible heat exchange tubes (41) are alternately and helically wound at a certain angle and is wound around an outside of the flexible inner tube (1).

In an implementation, the heat exchange apparatus (4) includes electric heating wires (42), which are helically wound around an outside of the flexible tube (5) and are configured to connect with a power supply and to heat the phase change material (7).

In an implementation, the variable stiffness tube further includes two sealing members (6). Each of the two sealing members (6) is arranged at a corresponding one of both ends of the flexible inner tube (1) and a corresponding one of both ends of the flexible outer tube (2). The two sealing members are attached to an outer wall of the flexible inner tube (1) and an inner wall of the flexible outer tube (2) and are configured to seal both ends of the filling space (3).

In an implementation, the phase change material (7) is a low-melting-point alloy.

The present disclosure further provides a variable stiffness module of a continuum robot, including the variable stiffness tube according to any of the above and a stiffness conversion control mechanism. The stiffness conversion control mechanism is connected with the heat exchange apparatus (4) and is configured to control the heat exchange apparatus (4).

Compared with the prior art, the embodiments have the following technical effects.

The embodiments provide a variable stiffness tube, a heat exchange apparatus arranged between a flexible outer tube and a flexible inner tube can exchange heat with a phase change material, thereby controlling phase change of the phase change material. By arranging a flexible tube in a filling space, multiple hollow slot groups are formed in a tube wall of the flexible tube in a penetrating manner, and the hollow slot is filled with the phase change material. When the phase change material is cooled to be in a solid phase, the flexible tube will be compressed on one side and stretched on the other side under the action of a bending moment, a spacing between sidewalls on both sides of the hollow slot of the flexible tube on the compressed side becomes smaller, the sidewalls of the flexible tube on both sides of the hollow slot can exert a squeezing effect on the phase change material in the hollow slot, making the phase change material undergo compressive stress. The stiffness of the variable stiffness tube is improved by enabling the phase change material to bear the compressive stress generated by a structure during bending deformation. After the phase change material undergoes heating and cooling cycles, the variable stiffness tube can regain high variable stiffness ratio capacity by self-healing.

The embodiments further provide a variable stiffness module of a continuum robot. A doctor can control stiffness change of the variable stiffness tube through a control mechanism, and the heat exchange apparatus is configured to provide heat to the phase change material to heat up and change the phase change material from a solid phase to a liquid phase state. The variable stiffness tube can bend freely to cooperate with a motion control module of the continuum robot to move to a target position. The variable stiffness tube can become relatively flexible when passing through a narrow channel to adapt to complex curved ducts and cavity structures inside the human body better, such as blood vessels and intestinal tracts, thereby reaching a surgical site more smoothly, with reduced damage to surrounding tissues and improved surgical safety. After confirming that a surgical tool has reached the surgical site via imaging means, the heat of the phase change material is absorbed through a human body temperature or the heat exchange apparatus to change the phase change material from the liquid phase to the solid phase by cooling, the stiffness of the variable stiffness tube is improved by the phase change material in the solid phase in the hollow slot of the flexible tube, an acting force is transmitted by the variable stiffness tube and applied to the surgical tool, allowing the surgical tool to complete a specified action.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is an exploded view of a structure of a variable stiffness tube according to an implementation;

FIG. 2 is a cross-sectional diagram of the structure of the variable stiffness tube according to the implementation;

FIG. 3 is a diagram of a nested structure of a flexible heat exchange tube, a flexible tube and an electric heating wire according to the implementation;

FIG. 4 is a diagram of a structure of the flexible tube according to the implementation;

FIG. 5 is a front view of a structure of the flexible tube according to the implementation;

FIG. 6 is a cross-sectional diagram of A-A of a structure of the flexible tube according to the implementation;

FIG. 7 is a diagram of a structure of the flexible heat exchange tube according to the implementation;

FIG. 8 is a diagram of the structure of the flexible heat exchange tube according to another implementation;

FIG. 9 is a diagram of a structure of a sealing member according to the implementation.

List of the reference characters: 1 flexible inner tube; 2 flexible outer tube; 3 filling space; 4 heat exchange apparatus; 41 flexible heat exchange tube; 42 electric heat wire; 5 flexible tube; 51 hollow slot group; 6 sealing member; 61 first through hole; 62 second through hole; 7 phase change material.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiments in the present disclosure, all other embodiments obtained by those of ordinary skill in the art without making creative labor fall within the scope of protection of the present disclosure.

The embodiments aim to provide a variable stiffness tube and a variable stiffness module of a continuum robot, thereby solving the problems in the prior art, improving stiffness of a tube body under the action of a bending moment, and reducing the deformation of the tube that undergoes the bending moment when a phase change material is in a solid phase.

To make the foregoing objectives, features and advantages of the present disclosure more apparent and easier to understand, the present disclosure will be further described in detail with the accompanying drawings and specific implementations.

### Embodiment I

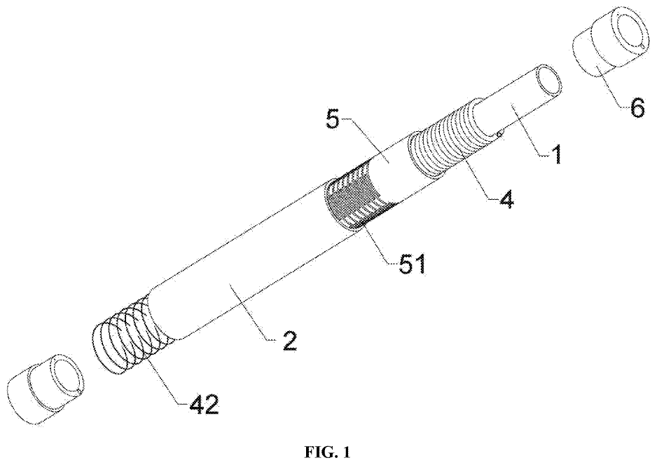

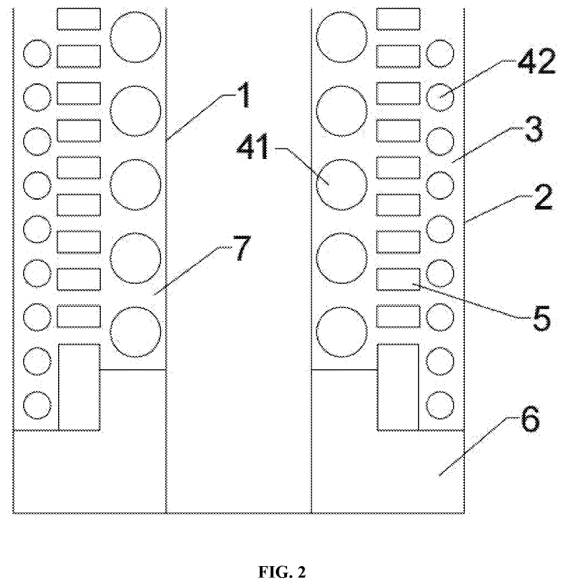

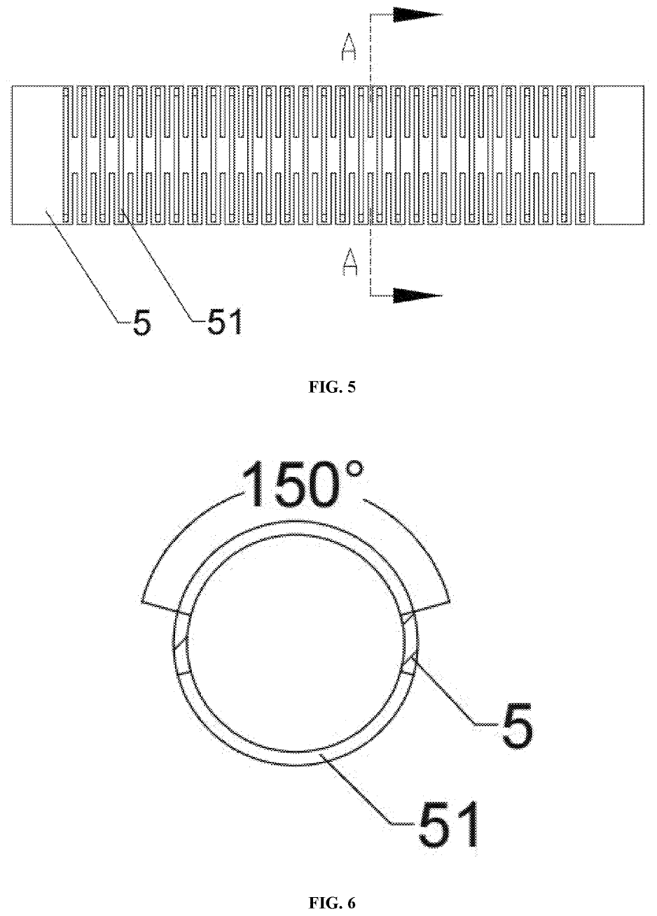

This embodiment provides a variable stiffness tube, as shown in FIG. 1 to FIG. 9, including a flexible inner tube 1 and a flexible outer tube 2 sleeved outside the flexible inner tube 1. A filling space 3 with both ends capable of being sealed is formed between the flexible inner tube 1 and the flexible outer tube 2. A phase change material 7 and a heat exchange apparatus 4 are arranged in the filling space 3. The heat exchange apparatus 4 can exchange heat with the phase change material 7 and cause the phase change material 7 to change from a solid phase to a liquid phase. A flexible tube 5 is further arranged in the filling space 3. Multiple hollow slot groups 51 are formed in a tube wall of the flexible tube 5 in a penetrating manner. The hollow slot group 51 includes at least one hollow slot, and the hollow slot is filled with the phase change material 7. When the phase change material 7 is in the liquid phase, the phase change material 7 can flow freely, and the flexible tube 5 can bend freely. When the phase change material 7 is in the solid phase, the flexible tube 5 will be compressed on one side and stretched on the other side under the action of a bending moment, a spacing between sidewalls on both sides of the hollow slot of the flexible tube on the compressed side becomes smaller, the sidewalls of the flexible tube on both sides of the hollow slot can exert a squeezing effect on the phase change material in the hollow slot, making the phase change material 7 undergo compressive stress. The stiffness of the variable stiffness tube is improved by enabling the phase change material 7 to bear the compressive stress generated by a structure during bending deformation. After the phase change material undergoes heating and cooling cycles, the variable stiffness tube can regain high variable stiffness ratio capacity by self-healing.

In another implementation of this embodiment, the flexible tube 5 is made of stainless steel. The stainless steel has high strength and can bear a large acting force, and also has excellent plasticity and toughness. The stainless steel can be manufactured and formed by various processing technologies, such as forging, rolling, extrusion, stretching, stamping, welding and cutting, and can meet the production of products with different shapes, sizes and precision requirements. The stainless steel material itself is nontoxic and harmless, cannot release a harmful substance, is harmless to human health and the environment, and thus is widely used in the technical field of medical devices.

In another implementation of this embodiment, the flexible tube 5 is made of a titanium alloy. The titanium alloy, due to its high strength, light weight and excellent biocompatibility, is one of ideal choices for a medical implant material.

In another implementation of this embodiment, the heat exchange apparatus 4 can further exchange heat with the phase change material 7 to cause the phase change material to change from the liquid phase to the solid phase, thereby improving the efficiency of changing the phase change material 7 from the liquid phase to the solid phase, and causing the phase change material 7 to have stiffness as soon as possible to bear the acting force.

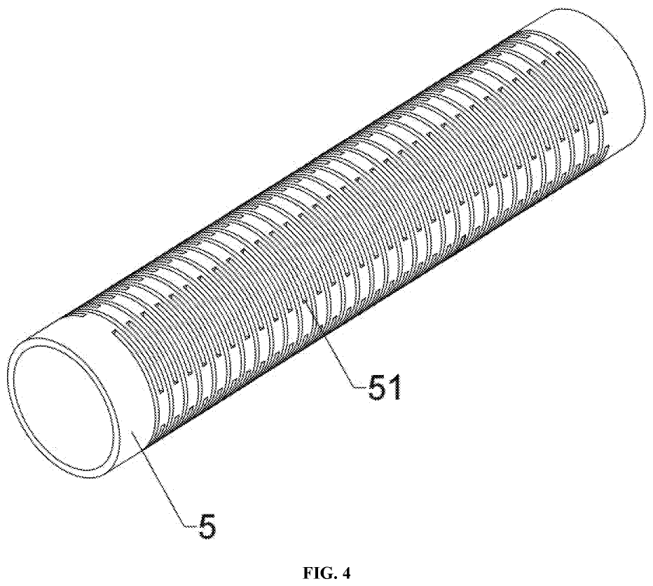

In another implementation of this embodiment, as shown in FIG. 4 to FIG. 6, each the hollow slot in the hollow slot group 51 is arranged along a circumferential direction of the flexible tube 5 and extends along the circumferential direction of the flexible tube 5, and a total perimeter of each hollow slot in the hollow slot group 51 is less than a perimeter of the flexible tube 5 to ensure continuity of the flexible tube. The hollow slots in the multiple hollow slot groups 51 are arranged alternately on the flexible tube 5 in an axial direction to reduce bending stiffness of the flexible tube 5 on the cross-section where the hollow slots are located. In the axial direction, projections of all hollow slots in any adjacent hollow slot groups 51 onto a cross-section of the flexible tube 5 completely cover the cross-section, such that the variable stiffness tube can bend freely when the phase change material 7 is in the liquid phase.

In another implementation of this embodiment, as shown in FIG. 4 to FIG. 6, a width of the hollow slot in the axial direction of the flexible tube 5 should be narrow as much as possible, preferably 0.1 mm-0.5 mm, and the density of the hollow slot should be high as much as possible, and a spacing between adjacent hollow slots is preferably 0.1 mm-0.5 mm. The hollow slots can be densely distributed on a sidewall of the flexible tube 5 by reducing the width of the hollow slot in the axial direction and the spacing between the hollow slots, and the restriction of the sidewall of the flexible tube 5 on the bending of the flexible tube 5 is reduced, thereby decreasing the bending stiffness of the flexible tube 5 when the phase change material 7 is in the liquid phase and increasing a curvature of the variable stiffness tube when bending. In an implementation, the hollow slot group 51 includes two hollow slots symmetrically arranged along a circumferential direction of the flexible tube 5, an included angle between a connecting line from a starting end of each hollow slot to the axis of the flexible tube 5 and a connecting line from a tail end of the hollow slot to the axis of the flexible tube 5 is preferably 140°-175°. By increasing the angle of the hollow slot, the area of a remaining tube wall of the flexible tube 5 is reduced, thereby decreasing the bending stiffness of the flexible tube 5 when the phase change material 7 is in the liquid phase. The axes of symmetry of any two adjacent hollow slot groups 51 are arranged orthogonally to avoid inconsistent bending stiffness of the flexible tube 5 in different directions. Through the foregoing configuration, the variable stiffness tube may have sufficient flexibility when the phase change material 7 is in the liquid phase.

In another implementation of this embodiment, a machining process of the hollow slot group 51 may include carrying out linear cutting on the flexible tube 5, a continuously moving thin metal wire is served as a tool electrode to perform pulsed spark discharge on the flexible tube 5 for eroding the tube wall, thereby achieving high-precision cutting and forming.

In another implementation of this embodiment, the shape of the hollow slot group 51 may be rectangular, oval or other shapes. The hollow slot groups 51 are densely distributed on the flexible tube 5 to make the bending stiffness of the flexible tube 5 approximately zero stiffness when the phase change material 7 is in the liquid phase.

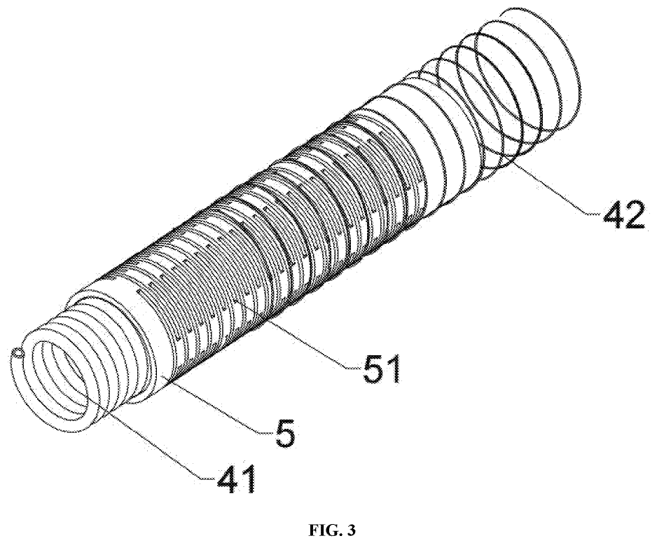

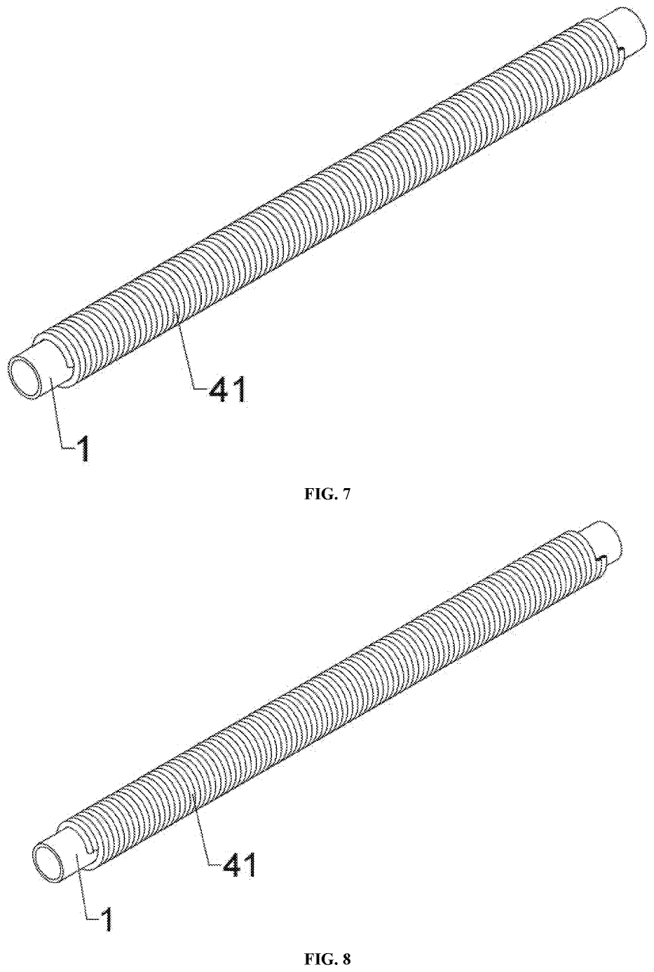

In another implementation of this embodiment, as shown in FIG. 3 and FIG. 7, the heat exchange apparatus 4 includes a flexible heat exchange tube 41, which is configured to allow a heat exchange medium to flow therein, enabling heat exchange with the phase change material 7. When the flexible heat exchange tube 41 is configured to heat the phase change material 7 in a solid state, the heat exchange medium can provide heat for the phase change material 7. As the heat is continuously input, the temperature of the phase change material 7 gradually increases, and the phase change material 7 can be changed from the solid state to a liquid state once a specified melting point of the phase change material 7 is reached. When the phase change material 7 in the liquid state is cooled, the heat exchange medium can absorb the heat of the phase change material, the heat is gradually transferred from the phase change material 7 to the flexible heat exchange tube 41. As the temperature of the phase change material 7 continues to decrease, the phase change material 7 can be changed from the liquid state to the solid state when reaching a freezing point.

In another implementation of this embodiment, the heat exchange medium, when providing the heat to the phase change material 7, may specifically be warm water at a temperature of 50 °C-100 °C, or silicone oil at a temperature of 50 °C-100 °C; and the heat exchange medium, when configured to absorb heat of the phase change material, may specifically be cold water at a temperature of 0-30 °C, or liquid nitrogen at a temperature below −196 °C.

In another implementation of this embodiment, each of the flexible inner tube 1 and the flexible outer tube 2 is made of polydimethylsiloxane (PDMS) or silica gel, with a thermal insulation coating applied to a surface thereof. The thermal insulation coating endows the tube wall with strong thermal insulation capacity, which can prevent the variable stiffness tube from causing damage to human tissues when a heat exchange medium is introduced.

In another implementation of this embodiment, as shown in FIG. 7, one flexible heat exchange tube 41 is provided, which is helically and seamlessly wound around the outside of the flexible inner tube 1. By seamlessly winding the flexible heat exchange tube around an outer side of the flexible inner tube 1, a contact area between the flexible heat exchange tube 41 and the phase change material 7 within a unit length of the variable stiffness tube is increased, thereby improving the heat exchange efficiency between the flexible heat exchange tube 41 and the phase change material 7.

In another implementation of this embodiment, as shown in FIG. 8, multiple flexible heat exchange tubes 41 are provided, preferably two flexible heat exchange tubes 41 are provided. The multiple flexible heat exchange tubes 41 are wound around the outside of the flexible inner tube 1 in parallel. By arranging the multiple flexible heat exchange tubes 41, the contact area between each flexible heat exchange tube 41 and the phase change material 7 is reduced, a flow velocity of the heat exchange medium is increased, and each flexible heat exchange tube 41 can exchange heat with the phase change material 7 within a contact range, such that the phase change material 7 within the contact range of each flexible heat exchange tube 41 can reach a critical temperature as soon as possible, and the heat exchange efficiency between the flexible heat exchange tube 41 and the phase change material 7 is improved.

In another implementation of this embodiment, multiple flexible heat exchange tubes 41 are provided, which are helically arranged in the filling space between the flexible inner tube 1 and the flexible outer tube 2 and can exchange heat with the phase change material 7 at the same time, thereby improving the heat exchange efficiency between the flexible heat exchange tubes 41 and the phase change material 7.

In another implementation of this embodiment, multiple flexible heat exchange tubes 41 are provided, which are alternately and helically wound around at a certain angle and are wound around the outside of the flexible inner tube 1, thereby exchanging heat with the phase change material 7.

In another implementation of this embodiment, multiple flexible heat exchange tubes 41 are provided, which are intertwined and are wound around each other at a certain angle to form a braided tube network, and the braided tube network is wound around the outside of the flexible inner tube 1 for heat exchange with the phase change material 7.

In another implementation of this embodiment, the flexible heat exchange tube 41 may be made of polytetrafluoroethylene (PTFE). The PTFE has excellent heat resistance, does not react with an environment medium, and can maintain sufficient stability during heat exchange with the phase change material.

In another implementation of this embodiment, the flexible heat exchange tube 41 may be made of a capillary copper tube or a capillary stainless steel tube. The capillary copper tube has excellent chemical stability and fluid transmission performance, can achieve accurate small-flow fluid transmission under a certain pressure difference, and is suitable for a device requiring micro-fluid control, such as a micro-injection apparatus in medical device.

In another implementation of this embodiment, the flexible heat exchange tube 41 may be made of carbon fiber reinforced resin. The carbon fiber reinforced resin is prepared by using carbon fibers, thermosetting or high-temperature thermoplastic resin as main raw materials, and has high thermal conductivity, good corrosion resistance, light weight, and high strength.

In another implementation of this embodiment, as shown in FIG. 3, the heat exchange apparatus 4 includes electric heating wires 42, which are helically wound around the outside of the flexible tube 5 and are configured to connect with a power supply and to heat the phase change material 7. The phase change material 7 is heated by the electric heating wire to change from a solid state to a liquid state, and under the action of the normal human body temperature, the phase change material 7 is changed from the liquid state to the solid state.

In another implementation of this embodiment, multiple electric heating wires 42 are provided, which are helically wound between the flexible inner tube 1 and the flexible outer tube 2 and are configured to connect with a power supply and to heat the phase change material 7. The phase change material 7 is heated by the electric heating wire to change from a solid state to a liquid state, and under the action of the normal human body temperature, the phase change material 7 is changed from the liquid state to the solid state.

In another implementation of this embodiment, as shown in FIG. 3, the flexible heat exchange tube 41 is helically and seamlessly arranged around the outside of the flexible inner tube and is configured to exchange heat with the phase change material 7 between the flexible inner tube 1 and the flexible tube 5. The electric heating wire 42 is wound around the outside of the flexible tube 5 and is configured to exchange heat with the phase change material 7 between the flexible tube 5 and the flexible outer tube 2. In conclusion, the heat exchange apparatuses 4 are arranged on the inner side and the outer side of the flexible tube 5 to improve the heat exchange efficiency between the heat exchange apparatuses 4 and the phase change material 7.

In another implementation of this embodiment, a specific winding spacing and winding mode of the heating wire 42 can be reasonably determined according to the required heating power.

In another implementation of this embodiment, the heat exchange apparatus 4 includes an optical fiber, and a grating is arranged on the optical fiber, and the optical fiber is arranged between the flexible inner tube 1 and the flexible outer tube 2. Light propagates in the optical fiber and is guided to the phase change material through the grating, such that the optical fiber can exchange heat with the phase change material 7. Based on thermal motion of microscopic particles (such as atoms and molecules) inside the optical fiber material, the heat is transferred from a region at a higher temperature to a region at lower temperature through mutual collision.

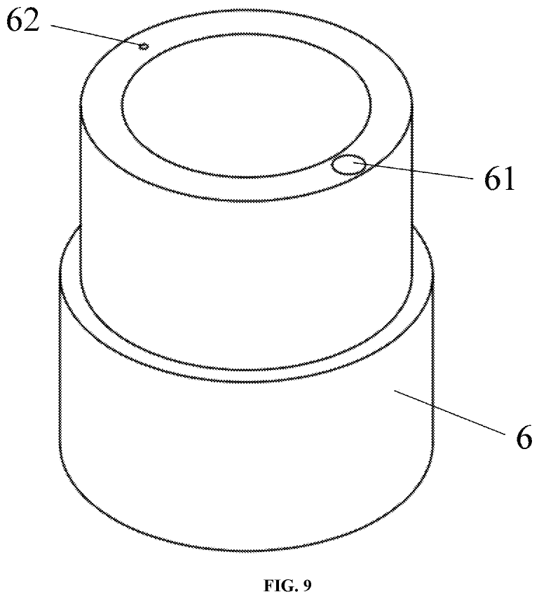

In another implementation of this embodiment, as shown in FIG. 9, the variable stiffness tube further includes sealing members 6, which are arranged at both ends of the flexible inner tube 1 and the flexible outer tube 2, and the sealing members can be attached to an outer wall of the flexible inner tube 1 and an inner wall of the flexible outer tube 2 and are configured to seal the filling space 3 between the flexible inner tube 1 and the flexible outer tube 2, thereby preventing the phase change material 7 between the flexible inner tube 1 and the flexible inner tube 2 from falling off from the filling space 3, and bearing the flexible tube 5 and the heat exchange apparatus 4.

In another implementation of this embodiment, as shown in FIG. 9, at least one through hole is formed in the sealing member 6 in a penetrating manner for the heat exchange apparatus to pass through, such that the heat exchange apparatus can communicate with an external heat source or cold source. The specific number of the through holes is determined in combination with a structural form of the heat exchange apparatus.

In another implementation of this embodiment, as shown in FIG. 9, a first through hole 61 and a second through hole 62 are formed in the sealing member 6 in a penetrating manner, the first through hole 61 is configured for the flexible heat exchange tube 41 to pass through, such that the flexible heat exchange tube 41 is configured to introduce a heat exchange medium, and the second through hole 62 is configured for the electric heating wire 42 to pass through, such that the electric heat wire 42 can be connected with the power supply, and the electric heat wire 42 is powered and heated.

In another implementation of this embodiment, the phase change material 7 is a low-melting-point alloy (LMPA). Specifically, the low-melting-point alloy may be Field's metal, Wood's alloy, or gallium-based alloy, and a melting point of the low-melting-point alloy is 47 degrees.

In another implementation of this embodiment, the low-melting-point alloy employs bismuth-indium-lead-tin-cadmium alloy. Specifically, the mass proportions of each element in the low-melting-point alloy are as follows: 45% of bismuth (with element symbol of Bi), 19% of indium (with element symbol of In), 23% of lead (with element symbol of Pb), 8% of tin (with element symbol of Sn), and 5% of cadmium (with element symbol of Cd).

In another implementation of this embodiment, the phase change material 7 is a thermoplastic material (TP). During phase change, the shape of the thermoplastic material can be kept relatively stable, and the thermoplastic material, unlike some inorganic phase change materials, does not suffer from problems such as container rupture caused by excessive volume expansion or contraction during phase change. The thermoplastic material also has good fluidity and is convenient to flow in the filling space between the flexible inner tube 1 and the flexible outer tube 2.

### Embodiment II

This embodiment further provides a variable stiffness module of a continuum robot, including the variable stiffness tube in Embodiment I and a stiffness conversion control mechanism. The stiffness conversion control mechanism is connected with a heat exchange apparatus 4 and is configured to control the heat exchange apparatus 4. A surgical tool is connected with a tail end of the variable stiffness tube, or a surgical tool is conveyed at an inner side of a flexible inner tube of the variable stiffness tube. A doctor can control stiffness change of the variable stiffness tube through the control mechanism, and the heat exchange apparatus is configured to provide heat to the phase change material to heat up and change the phase change material from the solid phase to the liquid phase state. The variable stiffness tube can bend freely to cooperate with a motion control module of the continuum robot to move to a target position. The variable stiffness tube can become relatively flexible when passing through a narrow channel to adapt to complex curved ducts and cavity structures inside the human body better, such as blood vessels and intestinal tracts, thereby reaching a surgical site more smoothly, with reduced damage to surrounding tissues and improved surgical safety. After confirming that a surgical tool has reached the surgical site via imaging means, the heat of the phase change material is absorbed through a human body temperature or the heat exchange apparatus to change the phase change material from the liquid phase to the solid phase by cooling, the stiffness of the variable stiffness tube is improved by the phase change material 7 in the solid phase in the hollow slot of the flexible tube 5, and an acting force is transmitted by the variable stiffness tube and applied to the surgical tool, allowing the surgical tool to complete a specified action.

Several examples are used for illustration of the principles and implementations of the present disclosure. The description of the embodiments is merely used to help illustrate the method and its core principles of the present disclosure. In addition, a person of ordinary skill in the art can make various modifications in terms of specific implementations and scope of application in accordance with the teachings of the present disclosure. In conclusion, the content of this specification shall not be construed as a limitation to the present disclosure.

What is claimed is:

1. A variable stiffness tube, comprising a flexible inner tube (1) and a flexible outer tube (2) sleeved outside the flexible inner tube (1), wherein a filling space (3) with both ends capable of being sealed is formed between the flexible inner tube (1) and the flexible outer tube (2), a phase change material (7) and a flexible heat exchange apparatus (4) are arranged in the filling space (3), and the heat exchange apparatus (4) is capable of exchanging heat with the phase change material (7) and causing the phase change material (7) to change from a solid phase to a liquid phase; a flexible tube (5) is further disposed in the filling space (3), a plurality of hollow slot groups (51) are formed in a tube wall of the flexible tube (5) in a penetrating manner, each of the plurality of hollow slot groups (51) comprises at least one hollow slot, and the at least one hollow slot is filled with the phase change material (7); and when the phase change material is in the liquid phase, the phase change material (7) is capable of flowing freely, and the flexible tube (5) is capable of bending freely.

2. The variable stiffness tube according to claim 1, wherein the heat exchange apparatus (4) is further capable of exchanging heat with the phase change material (7) to cause the phase change material (7) to change from the liquid phase to the solid phase.

3. The variable stiffness tube according to claim 1, wherein each of the at least one hollow slot in each of the plurality of hollow slot groups (51) is arranged along a circumferential direction of the flexible tube (5) and extends along the circumferential direction of the flexible tube (5), and a total perimeter of the at least one hollow slot in each of the plurality of hollow slot groups (51) is less than a perimeter of the flexible tube (5); hollow slots in the plurality of hollow slot groups (51) are arranged alternately on the flexible tube (5) in an axial direction; and in the axial direction, projections of all hollow slots in any adjacent hollow slot groups of the plurality of hollow slot groups (51) onto a cross-section of the flexible tube (5) completely cover the cross-section.

4. The variable stiffness tube according to claim 1, wherein the heat exchange apparatus (4) comprises one or more flexible heat exchange tubes (41), which is configured to allow a heat exchange medium to flow therein, enabling heat exchange with the phase change material (7).

5. The variable stiffness tube according to claim 4, wherein one flexible heat exchange tube (41) is disposed, and the one flexible heat exchange tube (41) is helically and seamlessly wound around an outside of the flexible inner tube (1).

6. The variable stiffness tube according to claim 4, wherein a plurality of flexible heat exchange tubes (41) are disposed, and the plurality of flexible heat exchange tubes (41) are alternately and helically wound at a certain angle and is wound around an outside of the flexible inner tube (1).

7. The variable stiffness tube according to claim 1, wherein the heat exchange apparatus (4) comprises electric heating wires (42), which are helically wound around an outside of the flexible tube (5) and are configured to connect with a power supply and to heat the phase change material (7).

8. The variable stiffness tube according to claim 1, further comprising two sealing members (6), wherein each of the two sealing members (6) is arranged at a corresponding one of both ends of the flexible inner tube (1) and a corresponding one of both ends of the flexible outer tube (2), and the two sealing members are attached to an outer wall of the flexible inner tube (1) and an inner wall of the flexible outer tube (2) and are configured to seal both ends of the filling space (3).

9. The variable stiffness tube according to claim 1, wherein the phase change material (7) is a low-melting-point alloy.

10. A variable stiffness module of a continuum robot, comprising the variable stiffness tube according to claim 1 and a stiffness conversion control mechanism, wherein the stiffness conversion control mechanism is connected with the heat exchange apparatus (4) and is configured to control the heat exchange apparatus (4).

11. The variable stiffness tube according to claim 4, wherein the heat exchange apparatus (4) comprises electric heating wires (42), which are helically wound around an outside of the flexible tube (5) and are configured to connect with a power supply and to heat the phase change material (7).

12. The variable stiffness module of a continuum robot according to claim 10, wherein the heat exchange apparatus (4) is further capable of exchanging heat with the phase change material (7) to cause the phase change material (7) to change from the liquid phase to the solid phase.

13. The variable stiffness module of a continuum robot according to claim 10, wherein each of the at least one hollow slot in each of the plurality of hollow slot groups (51) is arranged along a circumferential direction of the flexible tube (5) and extends along the circumferential direction of the flexible tube (5), and a total perimeter of the at least one hollow slot in each of the plurality of hollow slot groups (51) is less than a perimeter of the flexible tube (5); hollow slots in the plurality of hollow slot groups (51) are arranged alternately on the flexible tube (5) in an axial direction; and in the axial direction, projections of all hollow slots in any adjacent hollow slot groups of the plurality of hollow slot groups (51) onto a cross-section of the flexible tube (5) completely cover the cross-section.

14. The variable stiffness module of a continuum robot according to claim 10, wherein the heat exchange apparatus (4) comprises one or more flexible heat exchange tubes (41), which is configured to allow a heat exchange medium to flow therein, enabling heat exchange with the phase change material (7).

15. The variable stiffness module of a continuum robot according to claim 14, wherein one flexible heat exchange tube (41) is disposed, and the one flexible heat exchange tube (41) is helically and seamlessly wound around an outside of the flexible inner tube (1).

16. The variable stiffness module of a continuum robot according to claim 14, wherein a plurality of flexible heat exchange tubes (41) are disposed, and the plurality of flexible heat exchange tubes (41) are alternately and helically wound at a certain angle and is wound around an outside of the flexible inner tube (1).

17. The variable stiffness module of a continuum robot according to claim 10, wherein the heat exchange apparatus (4) comprises electric heating wires (42), which are helically wound around an outside of the flexible tube (5) and are configured to connect with a power supply and to heat the phase change material (7).

18. The variable stiffness module of a continuum robot according to claim 10, the variable stiffness tube further comprising two sealing members (6), wherein each of the two sealing members (6) is arranged at a corresponding one of both ends of the flexible inner tube (1) and a corresponding one of both ends of the flexible outer tube (2), and the two sealing members are attached to an outer wall of the flexible inner tube (1) and an inner wall of the flexible outer tube (2) and are configured to seal both ends of the filling space (3).

19. The variable stiffness module of a continuum robot according to claim 10, wherein the phase change material (7) is a low-melting-point alloy.

20. The variable stiffness module of a continuum robot according to claim 14, wherein the heat exchange apparatus (4) comprises electric heating wires (42), which are helically wound around an outside of the flexible tube (5) and are configured to connect with a power supply and to heat the phase change material (7).
